(19) United States
(12) Patent Application Publication
(10) Pub. No.: US 2013/0340493 A1
(43) Pub. Date: Dec. 26, 2013

(54) MULTI-BLADE AND LOCKING SYSTEM

(71) Applicant: Schlage Lock Company LLC, (US)

(72) Inventors: Sajil J. Mathachan, Bangalore, IN (US); Mohammed Maksood Ali, Bangalore (IN); Rohith Badhya, Bangalore (IN)

(21) Appl. No.: 13/890,176

(22) Filed: May 8, 2013

Related U.S. Application Data
(60) Provisional application No. 61/644,383, filed on May 8, 2012.

(51) Int. Cl. E05B 19/00; E05B 27/08

(52) U.S. Cl. CPC E05B 19/0052; E05B 27/08
USPC 70/493; 70/406

(57) ABSTRACT

An illustrative key includes outer blades connected to at an inner blade through a crossbar, with channels formed between adjacent blades. The inner blade is configured to engage a tumbling mechanism of a lock. The outer blades may obscure the bitting profile of the inner blade from view such that unauthorized duplication of the key is inhibited.

### CROSS REFERENCE TO RELATED APPLICATIONS

The present application claims the benefit of U.S. Provisional Patent Application No. 61/644,383 filed May 8, 2012, which is incorporated herein by reference.

### BACKGROUND

The present invention relates to keys and locks operable by the same. Key-operable locks may face a number of challenges that can compromise the security of the lock such as unauthorized duplication of the keys. Many conventional keys are easily copied, for example by taking an impression of the key or tracing its profile. Accordingly, there remains a need for further contributions in this area of technology. The present application provides novel and non-obvious contributions to this area of technology.

### SUMMARY

One embodiment of the present disclosure is a unique multi-blade key operable to be received in a keyway of a locking cylinder including a plurality of tumblers. Other embodiments include unique apparatuses, systems, devices, hardware, methods, and combinations for a multi-blade key and locking system. Further embodiments, forms, features, aspects, benefits, and advantages of the present application shall become apparent from the following description and drawings.

### BRIEF DESCRIPTION OF THE FIGURES

FIG. 1a is a perspective view of an example key according to one embodiment.

FIG. 1b illustrates a side view of a portion of the example key of FIG. 1a.

FIG. 2 is a perspective cutaway view of an example locking system.

FIG. 3 is a cross-sectional illustrative view of one embodiment the locking system of FIG. 2.

FIG. 4 is a cross-sectional illustrative view of another embodiment of the locking system of FIG. 2.

FIG. 5 is a perspective view of an example key blank according to an embodiment.

FIG. 6 is an illustrative view of one embodiment of a sidebar locking system.

### DETAILED DESCRIPTION OF ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

As used hereinafter, a reference to the length, height, or width of an element of a key is to be interpreted in light of the characterization of the dimensions and the following definitions unless specifically noted otherwise. The geometry of the key defines three mutually orthogonal axes; each dimension is measured along one of the axes. Width is measured along the first axis, defined as the direction in which the crossbar must extend to connect the blades. Width will be defined as the horizontal direction. Length is measured along a second axis defined as the axial direction of the shank. Height is measured along the third axis, the direction in which the bittings are formed (or in the case of a key blank, the direction in which bittings will be formed). The third axis will be defined as the vertical direction. The present application contemplates that the dimensions and orientation may be substantially in the direction indicated or in the direction indicated.

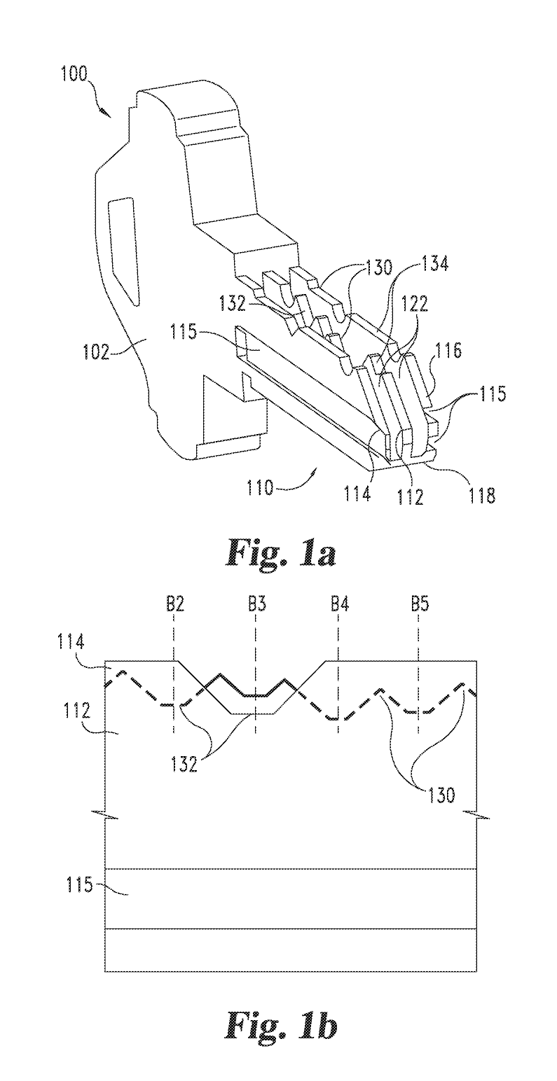

With reference to FIGS. 1a and 1b, there is illustrated an exemplary key 100 that includes a head portion 102 and a shank portion 110 extending in an axial direction from the head portion 102. Shank portion 110 includes an inner blade 112 and outer blades 114, 116. The present application contemplates in other embodiments that shank portion 110 may include a plurality of inner blades 112. Each blade has a width dimension in a horizontal direction, and a height dimension in the vertical direction that is greater than the width dimension. Inner blade 112 is separated in the horizontal direction from outer blades 114, 116 by channels 122. In one form blades 112, 114, 116 extend parallel to one another in the axial direction and in another form extend substantially parallel to one another in the axial direction. In the illustrated embodiment, blades 112, 114, 116 also extend parallel to one another in the vertical dimension and in another form extend substantially parallel to one another in the vertical direction. In other embodiments, one or more of the blades may be at an oblique angle to another of the blades.

A crossbar 118 extends between and fixedly couples the blades to one another. In one form the crossbar 118 extends a width dimension corresponding to the width dimension of the shank portion and in another form extends a width dimension corresponding substantially to the width dimension of the shank portion. In certain embodiments, crossbar 118 also extends the length of shank portion 110 in a contiguous manner. In other embodiments crossbar 118 may be formed in axial spaced sections. Crossbar 118 is illustrated as connecting blades 112, 114, 116 at the bottom ends thereof. In other embodiments, a crossbar may connect the blades at another location, such as the center of the blades. While key 100 in one form is a unitary integrally formed item, it is also contemplated that one or more elements thereof may be separately manufactured and coupled together to form the key. For example, shank portion 110 may be a single piece which is attached to head portion 102 after manufacturing.

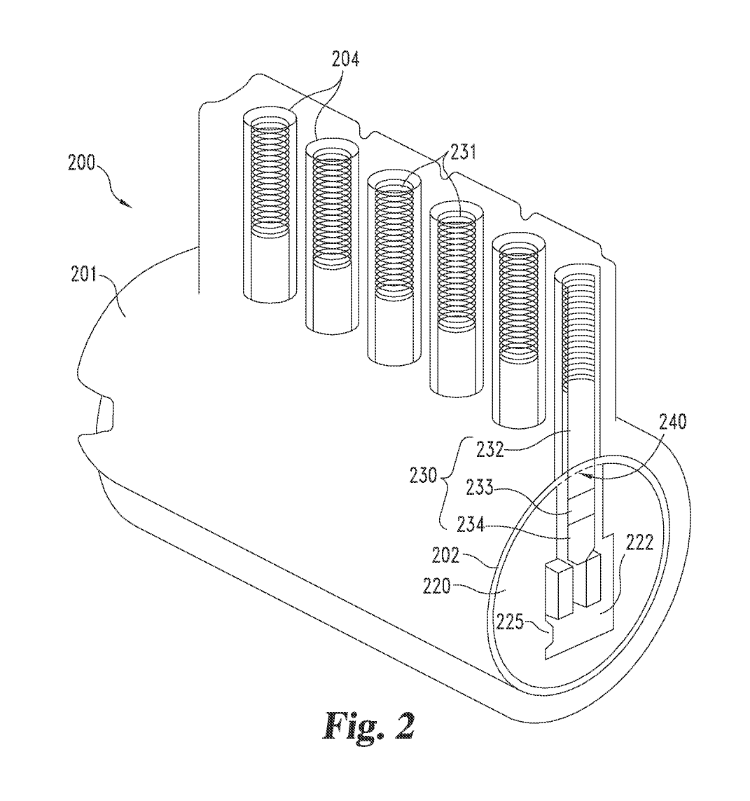

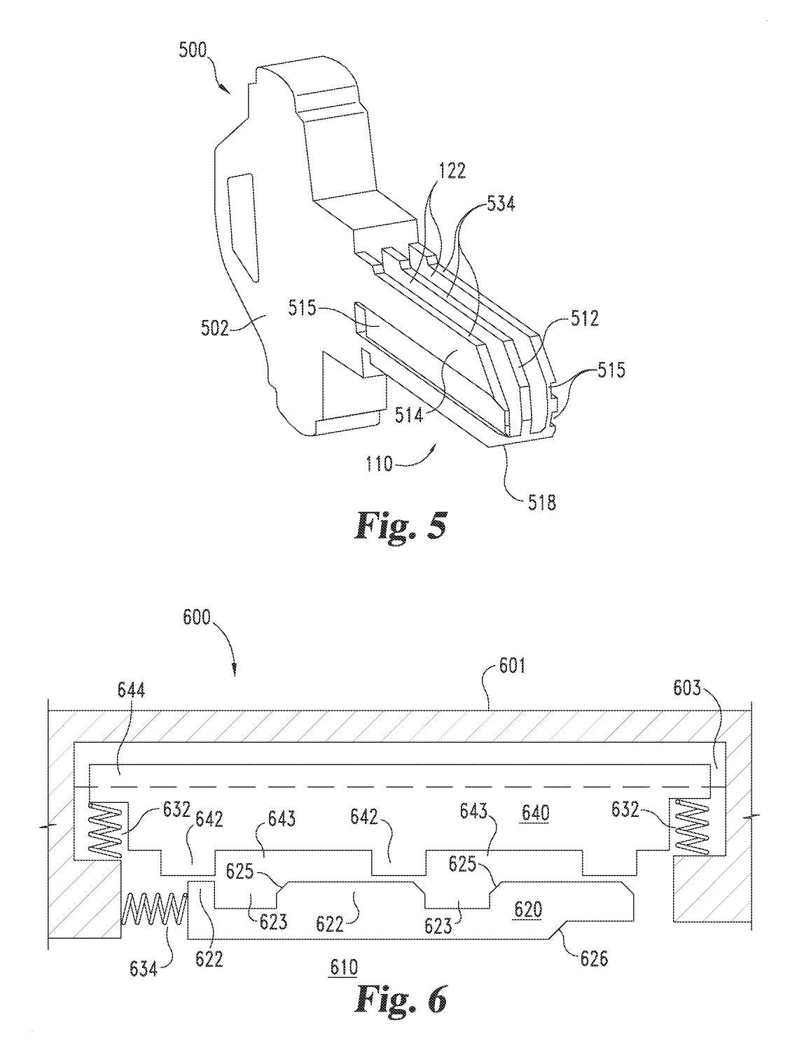

Shank portion 110 has a plurality of bitting positions (a subset of which is illustrated in FIG. 1b as bitting positions B2-B5) spaced such that each bitting position corresponds to the position of a tumbler in a corresponding locking cylinder. In the illustrated embodiment, bittings 132 are formed on the top surface 134 of inner blade 112 at bitting positions B2-B5, and teeth 130 are defined therebetween. In certain embodiments, bittings 132 may also be formed on the top surface 134 of one or more of outer blades 114, 116. In other embodiments, bittings 132 may be formed only on inner blade 112. In yet another embodiment bittings 132 are formed on the inner blades and the outer blades. One embodiment of a key having no bittings is described below with respect to FIG. 5. Bittings 132 are sized and positioned such that when shank portion 110 is inserted into a corresponding lock, the tumblers of the lock align with a shear line 240 (see FIG. 2), such that the plug portion is rotatable with respect to the shell. Shank portion 110 and the features described hereinabove may be formed by any methods known in the art, such as stamping, casting, milling, and broaching.

One or more of blades 112, 114, 116 and crossbar 118 may include a groove 115. Groove 115 may be configured to receive a counter-shaped/correspondingly-shaped ward in a corresponding keyway, and/or include side-bitting (not shown) to provide additional security. Outer blades 114, 116 may be configured such that at least a section thereof is of a greater height dimension than a corresponding section of inner blade 112 such that the profile of inner blade 112 is obscured from view. In this way, unauthorized duplication of the key profile—such as making an impression of the key or by tracing the profile of the key—is inhibited.

With reference to FIGS. 2-4, there is illustrated an exemplary lock assembly 200 that includes a shell 201 and a plug 220. Shell 201 defines a plug cavity 202 in which plug 220 is rotatably positioned. Plug cavity 202 is generally cylindrical, but may include one or more grooves (not shown), for example if plug 220 includes sidebar locking features. In one form, plug 220 includes a keyway 222 configured to receive a shank portion 210 including an inner blade 212 and outer blades 214, 216.

Keyway 222 includes a first blade slot configured to receive inner blade 212, a second blade slot configured to receive outer blade 214, a third blade slot configured to receive outer blade 216, and a crossbar slot configured to receive crossbar 118. Each of the slots extends into plug 220 along the axial direction. In the illustrated embodiment, the first blade slot is aligned with a central axial plane of plug 220, although other configurations are contemplated. Keyway 222 may include a ward 225 configured to prevent entry of a shank portion that does not include a counter-shaped/correspondingly-shaped groove 215. Plug 220 further includes a plurality of plug tumbler cavities 224 configured to align with corresponding shell tumbler cavities 204 formed in shell 210, thereby creating tumbler chambers.

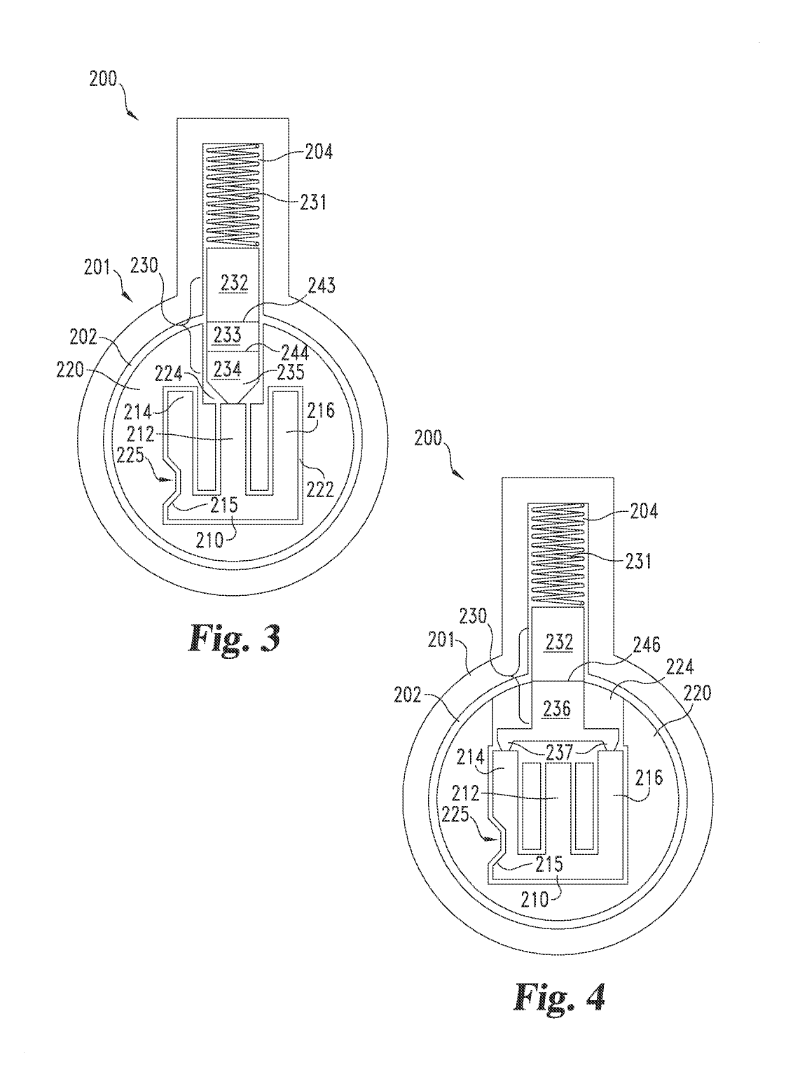

Disposed within each tumbler chamber is a spring 231 and a tumbling system, here illustrated as tumbler set 230. Each tumbler set 230 includes a driving pin 232 and a driven tumbler, which may be a bottom pin 234 (see FIG. 3) or a T-member 236 (see FIG. 4). One or more tumbler sets 230 may further include one or more master key pins 233 disposed between driving pin 232 and the driven tumbler, such that lock assembly 200 may be master-keyed. Spring 231 provides a biasing force urging driving pin 232 toward plug tumbler cavity 224. As illustrated in FIG. 2, when keyway 222 is empty, spring 231 biases driving pin 232 downward and partially into tumbler cavity 224 such that plug 220 is not rotatable with respect to shell 201.

FIG. 3 illustrates a tumbler set 230 including a master key pin 233 and a bottom pin 234. Driving pin 232 contacts master key pin 233 at interface 243, and master key pin 233 contacts bottom pin 234 at interface 244. In one form bottom pin 234 includes a tapered or curved tip 235, however other geometries are contemplated herein. Tip 235 is configured such that when shank portion 210 is inserted into keyway 222, tip 235 travels along the contact surface of inner blade 212, and bottom pin 234 moves in a vertical direction of the tumbler chamber. When bottom pin 234 is in the proper position—as when a correct key is inserted and tip 235 is in contact with the corresponding bitting of inner blades 212—bottom pin 234 does not protrude into shell tumbler cavity 204, driving pin 232 does not protrude into plug tumbler cavity 224, and master key pin 233 either does not protrude into shell tumbler cavity 204 or does not protrude into plug tumbler cavity 224. That is to say, a shear line 240 is substantially aligned with either interface 243 or interface 244, such that neither driving pin 232, master key pin 233, nor bottom pin 234 prevent rotation of plug 220 with respect to shell 201.

FIG. 4 illustrates a tumbler set 230 including a driving pin 232 and a T-member 236. T-member 236 contacts driving pin 232 at an interface 246, and has tapered or curved tips 237. The tips 237 can have other geometries. Tips 237 are configured such that when shank portion 210 is inserted into keyway 222, tip 237 travels along the contact surfaces of outer blades 214, 216 and T-member 236 moves in an vertical direction of the tumbler chamber. When T-member 236 is in the proper position—as when the correct key is inserted and tips 237 are in contact with the corresponding bittings of outer blades 214, 216—T-member 236 does not protrude into shell tumbler cavity 204, and driving pin 232 does not protrude into plug tumbler cavity 224. That is to say, interface 246 is substantially aligned with shear line 240 such that neither driving pin 232 nor T-member 236 prevents rotation of plug 220 with respect to shell 201. In the embodiment illustrated in FIG. 4, no master key pin is included. In other embodiments, tumbler sets 230 which include a T-member 236 may also include one or more master key pins.

When the proper shank portion 210 is inserted into keyway 222, an interface 243, 244, 246 in each tumbling system is substantially aligned with shear line 240. This defines an unlocked state of locking system 200, in which plug 220 is free to rotate with respect to shell 201. In the illustrated embodiment, the tumbling systems are sets of pin tumblers. In other embodiments, the tumbling systems may include other types of tumblers, such as wafer tumblers or disc tumblers. Furthermore, while locking assembly 200 is illustrated as a six-tumbler, small-format interchangeable core, other formats and tumbler counts may be used.

FIG. 5 illustrates an example key blank 500 according to one embodiment. Key blank 500 is substantially similar to key 100, and similar reference characters have been used to indicate similar features. In key blank 500, the top surfaces 534 of each blade are substantially flat, such that key blank 500 may later be bitted to specification.

With reference to FIG. 6, an illustrative sidebar locking system 600 includes a sidebar 640 and a sliding member 620. Sidebar 640 includes a tapered portion 644 and sidebar protrusions 642 opposite tapered portion 644. Sidebar protrusions 642 are separated by sidebar recesses 643. Biasing members 632 bias sidebar 640 radially outward into a counter-shaped groove 603 formed in a shell 601, such that sidebar 640 crosses a shear line 604.

Sliding member 620 includes sliding member protrusions 622 spaced by sliding member recesses 623. Sliding member protrusions 622 are configured to be received by sidebar recesses 643, and sliding member recesses 623 are configured to receive sidebar protrusions 642. Sliding member 620 is biased toward an entry of keyway 610 by a biasing member 634.

In a first position, sidebar protrusions 642 contact sliding member protrusions 622 such that sidebar 640 is not free to travel radially inward. When a proper key is inserted, a protrusion on the key—for example, formed in a groove such as groove 115—contacts a ridge 626, and sliding member 620 travels to a second position. In the second position, sliding member protrusions 622 are substantially aligned with sidebar recesses 643 and sidebar protrusions 642 are substantially aligned with sliding member recesses 623, such that sidebar 640 is free to travel radially inward. When the key is removed, sliding member 620 returns to its original position due to the force exerted by biasing member 634.

In the illustrated embodiment, sliding member protrusions 622 are provided with tapered surfaces 625 such that minor misalignment of the protrusions and recesses does not prevent sidebar 640 from traveling radially inward. In other embodiments, one or more of sliding member protrusions 622 may not include tapered surfaces 625, and/or tapered surfaces may be provided to one or more of sidebar protrusions 642.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A key configured to be received in a keyway of a locking cylinder including a plurality of tumblers, the key comprising:
a shank portion including a crossbar having a crossbar width extending in a substantially horizontal direction and a crossbar length extending in a substantially axial direction; and
a plurality of spaced apart blades extending from the crossbar, each of the plurality of blades having a width dimension in the substantially horizontal direction and a height dimension in the substantially vertical direction, the height dimension being greater than the width dimension, and a channel is formed between adjacent blades, the plurality of blades comprising:
an inner blade extending from the crossbar in a substantially vertical direction and including a top surface configured to interface with the tumblers of the locking cylinder; and
a plurality of outer blades extending from the crossbar such that the outer blades and inner blade are substantially parallel with respect to the substantially axial direction.

2. The key of claim 1, wherein the substantially horizontal direction is defined as a horizontal direction;
wherein the substantially axial direction is defined as an axial direction;
wherein the substantially vertical direction is defined as a vertical direction; and
wherein substantially parallel is defined as being parallel.

3. The key of claim 2, wherein bitting positions are defined by axial sections of the shank, wherein each of the plurality of blades has a root depth at each of the bitting positions, wherein the root depth extends in the vertical direction, and wherein the root depth dimension of the inner blade at a first bitting position is less than the root depth dimension of another of the plurality of blades at the first bitting position.

4. The key of claim 3, wherein the root depth dimension of the inner blade at each bitting position is less than the root depth dimension at the same bitting position of at least one of another of the plurality of blades.

5. The key of claim 3, wherein the root depth dimension of the inner blade at a second bitting position is greater than the root depth dimension of another of the plurality of blades at the second bitting position.

6. The key of claim 2, wherein each of the blades is perpendicular to the crossbar.

7. The key of claim 6, wherein the shank includes a groove configured to receive a correspondingly-shaped ward defined by the locking cylinder.

8. The key of claim 2, wherein the root depth dimension of the inner blade at each of the bitting positions is different than the root depth dimension of the inner blade at another of the bitting positions, and wherein the inner blade is configured to adjust the position of at least one of the tumblers to an unlocked position.

9. An apparatus comprising:
a cylindrical plug extending along an axial direction and including a keyway and an opening on a circumferential outer surface of the plug;
the keyway including a first blade slot, a second blade slot, a third blade slot and a crossbar slot, each of the slots extending into the plug along the axial direction, the first blade slot is connected to the opening and aligned with a central axial plane of the plug and disposed between the second and third blade slots, and the crossbar slot connects the three blade slots; and
a tumbling system including a first portion positioned in the first blade slot, a second portion positioned in the opening, and a third portion protruding outward from the outer surface of the plug, the tumbling system being operable between an unlocked state in which an interface of the tumbling system is aligned with the circumferential outer surface of the plug, and a locked state in which the interface is not aligned with the circumferential outer surface of the plug.

10. The apparatus of claim 9, wherein the plug further defines a second opening connected to the second blade slot;
further comprising a second tumbling system including a first portion positioned in the second blade slot, a second portion positioned in the second opening, and a third portion protruding outward from the outer surface of the plug, the second tumbling system being operable between an unlocked state in which an interface of the second tumbling system is aligned with the circumferential outer surface of the plug, and a locked state in which the interface is not aligned with the circumferential outer surface of the plug.

11. The apparatus of claim 9, wherein the three blade slots are parallel to one another, and wherein the crossbar slot is perpendicular to the three blade slots.

12. A key configured to be received in a keyway of a locking cylinder having a plurality of tumblers, the key comprising:
a shank having a shank length corresponding to an axial length of the keyway, the shank including:
an inner blade having an inner blade width and an inner blade height greater than the inner blade width, and an inner blade length greater than the inner blade height, wherein the inner blade width extends in a horizontal direction, the inner blade height extends in a vertical direction, and the inner blade length extends in an axial direction;
a plurality of outer blades with at least one of the plurality of outer blades positioned on opposing sides of the inner blade, the plurality of blades extend parallel to one another in the axial direction; and
a crossbar fixedly coupling the inner blade to the outer blades and a channel is formed between each of the adjacent plurality of blades, the channel defining a space between adjacent blades.

13. The key of claim 12, wherein the inner blade has an inner blade length, and each outer blade has an outer blade length corresponding to the inner blade length.

14. The key of claim 12, wherein the inner blade has a plurality of heights such that the height of the inner blade at a first location along the inner blade includes a top surface configured to change the position of a first of the plurality of tumblers to a position in which the first of the plurality of tumblers does not extend beyond a shear line of the locking cylinder.

15. The key of claim 14, wherein the inner blade is configured to change the positions of each of the plurality of tumblers to positions in which the each of the plurality of tumblers does not extend beyond a shear line of the locking cylinder.

16. The key of claim 14, wherein at a first location along the axial direction, the height of one of the outer blades is at least as great as the height of the inner blade.

17. The key of claim 15, wherein at each location along the length direction, the height of one of the outer blades is at least as great as the height of the inner blade.

18. The key of claim 16, wherein at a second location along the length direction, the height of each of the outer blades is at least as great as the height of the inner blade.

19. The key of claim 15, wherein a first of the outer blades has a plurality of heights.

20. The key of claim 19, wherein the first outer blade is configured such that the first outer blade top surface is configured to change the position of a second of the plurality of tumblers to a position in which the second of the plurality of tumblers does not protrude beyond a shear line of the locking cylinder.

21. The key of claim 11, wherein a bottom surface of the crossbar defines a bottom surface of the shank portion.
